(19) United States
(12) Patent Application Publication
(10) Pub. No.: US 2026/0238090 A1
(43) Pub. Date: Aug. 13, 2026

(54) TEMPERATURE SENSOR POSITIONED BETWEEN BUSBAR AND PHASE PINS

(71) Applicant: Schaeffler Technologies AG & Co. KG, Herzogenaurach (DE)

(72) Inventor: Pedro Angel Hernandez, Irapuato (MX)

(21) Appl. No.: 19/048,114

(22) Filed: Feb. 7, 2025

(51) Int. Cl. H02K 11/25; H02K 3/50

(52) U.S. Cl. CPC H02K 11/25; H02K 3/50; H02K 2203/09

(57) ABSTRACT

A busbar may include bars, bus pins connected to the bars, a neutral bus, and an overmold. The overmold may support the bars, the bus pins, and the neutral bus. The overmold may also include a mounting point, wherein the overmold is configured to couple to a temperature sensor at the mounting point. A stator may include the busbar, a temperature sensor, and a winding. The winding may be made of hairpins. The temperature sensor may be coupled to the mounting point and additionally abuts at least one of the neutral bus or one or more bus pin. An electric motor may include the stator and a rotor.

### TECHNICAL FIELD

The present disclosure generally relates to electrical motors, and, more particularly, to temperature measurements within the electrical motors.

### BACKGROUND

Temperature sensors are used in three-phase electric motors. The temperature sensors may measure a temperature of a stator winding within the three-phase electric motors. The temperature sensor may couple to a hairpin of the winding using a plastic component. The function of the plastic component may be to couple the temperature sensor to the hairpin. The addition of the plastic component may require additional parts and time-of-assembly for the three-phase electric motors. Therefore, it would be advantageous to provide a device, system, and method that cures the shortcomings described above.

### SUMMARY

A busbar is described, in accordance with one or more embodiments of the present disclosure. The busbar may include: a plurality of bars; a plurality of bus pins, wherein the plurality of bus pins are connected to the plurality of bars; a neutral bus; and an overmold configured to support the plurality of bars, the plurality of bus pins, and the neutral bus, wherein the overmold comprises: a mounting point, wherein the overmold is configured to couple to a temperature sensor at the mounting point.

In some aspects, the temperature sensor is located between the plurality of bus pins and the overmold.

In some aspects, the temperature sensor is in contact with at least two bus pins of the plurality of bus pins.

In some aspects, the temperature sensor is molded within the overmold.

In some aspects, the temperature sensor is in contact with the neutral bus.

In some aspects, the temperature sensor is located between the overmold and the neutral bus.

In some aspects, the temperature sensor runs perpendicular to the plurality of bus pins.

In some aspects, the temperature sensor is located at a corner of the busbar.

In some aspects, the temperature sensor is located proximal to the neutral bus.

In some aspects, the overmold is configured such that the temperature sensor is at least one of press fit or snap fit into the overmold.

In some aspects, the busbar is a three-phase busbar, wherein the plurality of bars comprise a first-phase bar, a second-phase bar, and a third-phase bar, wherein the plurality of bus pins comprise a plurality of first-phase bus pins, a plurality of second-phase bus pins, and a plurality of third-phase bus pins, wherein the plurality of first-phase bus pins are connected to the first-phase bar, wherein the plurality of second-phase bus pins are connected to the second-phase bar, wherein the plurality of third-phase bus pins are connected to the third-phase bar.

In some aspects, a first set of the plurality of first-phase bus pins, the plurality of second-phase bus pins, and the plurality of third-phase bus pins are disposed along an inner-radius, wherein a second set of plurality of first-phase bus pins, the plurality of second-phase bus pins, and the plurality of third-phase bus pins are disposed along an outer-radius. A stator is described, in accordance with one or more embodiments of the present disclosure. The stator may include: a busbar including: a plurality of bars; a plurality of bus pins, wherein the plurality of bus pins are connected to the plurality of bars; a neutral bus; and an overmold configured to support the plurality of bars, the plurality of bus pins, and the neutral bus, wherein the overmold comprises: a mounting point, wherein the overmold is configured to couple to a temperature sensor at the mounting point; a stator core; a winding, wherein the winding is electrically connected to the plurality of bus pins and the neutral bus, the winding comprising a plurality of hairpins; and the temperature sensor, wherein the temperature sensor is coupled to the mounting point and additionally abuts at least one of the neutral bus or one or more pins of the plurality of bus pins.

In some aspects, the temperature sensor is located between the plurality of bus pins and the overmold.

In some aspects, the temperature sensor is molded within the overmold.

In some aspects, the temperature sensor is located between the overmold and the neutral bus.

An electric motor is described, in accordance with one or more embodiments of the present disclosure. The electric motor may include: a rotor and a stator including: a busbar including: a plurality of bars; a plurality of bus pins, wherein the plurality of bus pins are connected to the plurality of bars; a neutral bus; and an overmold configured to support the plurality of bars, the plurality of bus pins, and the neutral bus, wherein the overmold comprises: a mounting point, wherein the overmold is configured to couple to a temperature sensor at the mounting point; a stator core; a winding, wherein the winding is electrically connected to the plurality of bus pins and the neutral bus, the winding comprising a plurality of hairpins; and the temperature sensor, wherein the temperature sensor is coupled to the mounting point and additionally abuts at least one of the neutral bus or one or more pins of the plurality of bus pins.

In some aspects, the temperature sensor is located between the plurality of bus pins and the overmold.

In some aspects, the temperature sensor is molded within the overmold.

In some aspects, the temperature sensor is located between the overmold and the neutral bus.

### BRIEF DESCRIPTION OF THE DRAWINGS

The numerous advantages of the disclosure may be better understood by those skilled in the art by reference to the accompanying figures in which:

FIG. 1A depicts a front perspective view of a busbar, in accordance with one or more embodiments of the present disclosure.

FIG. 1B depicts a front perspective view of a busbar with a temperature sensor coupled to the overmold, in accordance with one or more embodiments of the present disclosure.

FIG. 1C depicts a front perspective view of a busbar with a temperature sensor coupled to the overmold, in accordance with one or more embodiments of the present disclosure.

FIG. 2A depicts a partial front perspective view of a stator with the busbar, in accordance with one or more embodiments of the present disclosure.

FIG. 2B depicts a front perspective view of the stator with the busbar, in accordance with one or more embodiments of the present disclosure.

FIG. 2C depicts a partial-front perspective view of the stator with the busbar, in accordance with one or more embodiments of the present disclosure.

FIG. 3 depicts an electric motor with the stator, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to a busbar. The busbar may include bars, bus pins connected to the bars, a neutral bus, and an overmold. The overmold may support the bars, the bus pins, and the neutral bus. The overmold may also include a connection point where a temperature sensor may couple to the overmold. The winding may be made of hairpins. The temperature sensor may be located between the bus pins and the overmold. The temperature sensor may also be located between the overmold and the neutral bus.

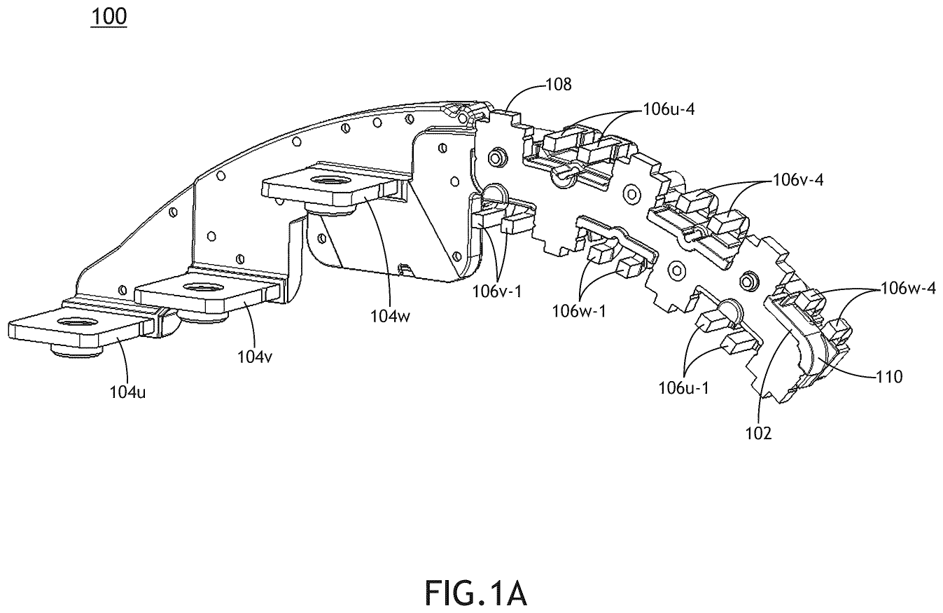

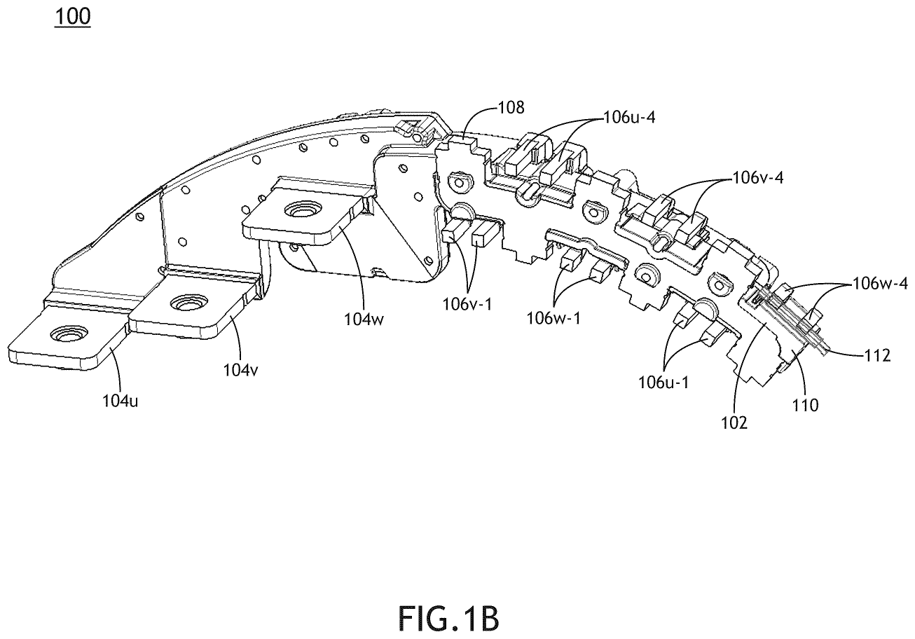

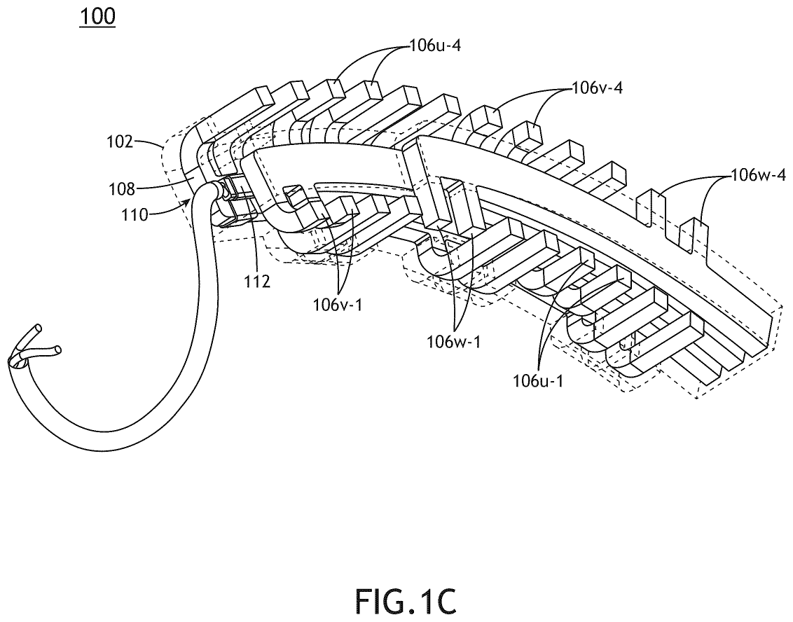

FIGS. 1A-1C depict a busbar 100, in accordance with one or more embodiments of the present disclosure. The busbar 100 may be a connection bar for a stator of an electric motor. The busbar 100 may include one or more components, such as, but not limited to, an overmold 102, bars 104, bus pins 106, and/or a neutral bus 108.

The busbar 100 may receive and distribute three currents. For example, the bus pins 106 may receive the current by the bars 104 and distribute the current from the bus pins 106. The bars 104, the bus pins 106, the neutral bus 108 and/or the hairpins 208 may be made from any electrically conductive material. The electrically conductive material may be a rigid metallic element formed from metal. For example, the bars 104, the bus pins 106, the neutral bus 108 may be made from copper, a copper alloy, or the like.

The overmold 102 may support the bars 104, the bus pins 106, and the neutral bus 108. For example, the bars 104, the bus pins 106, and the neutral bus 108 may be coupled to the overmold 102. The overmold 102 may bear the weight from the bars 104, the bus pins 106, and the neutral bus 108.

The overmold 102 may include a mounting point 110. The mounting point 110 may be configured such that the mounting point 110 receives and couples a temperature sensor 112 to the overmold 102. The mounting point 110 may be formed during production of the overmold 102 (e.g., during injection molding of the overmold 102).

The mounting point 110 may be located at any position on the overmold 102. For example, the mounting point 110 may be at the center of the overmold 102. By way of another example, the mounting point 110 may be located at an end or a corner of the overmold 102. It is contemplated that placing the mounting point 110 at the end or a corner of the overmold 102 may be preferred because at the end or a corner of the overmold 102, there may be less interference with existing wires.

The mounting point 110 may also be configured in any manner to hold a temperature sensor 112 such that the temperature sensor 112 provides accurate temperature readings. For example, an oil spray may be used to cool various components. If a substantial amount of the oil spray makes contact with the temperature sensor 112, the temperature sensor 112 may provide inaccurate readings.

For example, and shown in FIG. 1B, the mounting point 110 may be positioned and configured in such a way where the temperature sensor 112 is located between the bus pins 106 and the overmold 102. In this way, the mounting point 110 may contact the temperature sensor 112 from one side (e.g., from below) while the bus pins 106 contact the temperature sensor 112 from another side (e.g., from above). It is contemplated that the temperature sensor 112 may provide better readings when it is in contact with larger surface areas. Therefore, the temperature sensor 112 may be positioned such that it is in contact with at least two bus pins. However, if such a positioning is not possible, positioning the temperature sensor 112 to be in contact with a single bus pin 106 may provide sufficiently accurate temperature measurements. The temperature sensor 112 may be configured such that it runs perpendicular to the bus pins 106. The temperature sensor 112 may be axially aligned between the bus pins 106 and the mounting point 110. The temperature sensor 112 may also be coupled to a circumferential end of the busbar 100 disposed opposite to the bars 104. For example, the temperature sensor 112 may be arranged perpendicular to and span across at least two of the bus pins 106 which are disposed along an outer radius of the busbar 100 and at a circumferential end of the busbar 100 opposite to the bars 104.

By way of another example, and shown in FIG. 1C, the temperature sensor 112 may be molded within the overmold 102. The temperature sensor 112 may be configured to be in contact or proximal to the neutral bus 108. In this way, the mounting point 110 may contact the temperature sensor 112 from one side (e.g., from above) while the neutral bus 108 contacts the temperature sensor from another side (e.g., from below). The neutral bus 108 may be one of the hottest places as various currents flow through the neutral bus 108.

Additionally, the mounting point 110 may be configured such that the temperature sensor 112 is press fit or snap fit into the mounting point 110. It is contemplated that the mounting point 110 may be required to hold the temperature sensor 112 completely still, as movement of the temperature sensor 112 may result in inaccurate temperature readings or temperature readings of an undesired location.

It is contemplated that in order to receive accurate temperature readings, it may be desirable for the temperature sensor 112 to abut only the bus pins 106 or the neutral bus 108, but not both. In this regard, the temperature sensor 112 may abut to the bus pins 106 or the neutral bus 108, and be separated from the other of the bus pins 106 or the neutral bus 108 by the overmold 102.

The overmold 102 may be an electrical insulator. The overmold 102 may be any material which is an electrical insulator to insulate the bars 104, the bus pins 106, and the neutral bus 108. The overmold 102 may be made of a plastic material or the like. The plastic material may include one or more material properties, such as, but not limited to, high electrical resistance, high rigidity, high shock resistance, high resilience, high resistance to thermal deformation, very high dimensional stability, good sliding properties, good fatigue resistance, easy to machine, and/or good resistance to chemicals such as organic solvents and fuels.

The plastic material may include, but is not limited to, polyamide (PA66), Polyphthalamide (PPA), or the like. For example, the polyamide may be PA6, PA66, or the like. The plastic material may be a fiber-reinforced matrix which is impregnated with one or more fibers. The fibers may include glass, fiberglass, carbon fiber, aramid, carbon fibers, or the like. The fibers may include a load percentage. The load percentage of the fibers may be between 30% and 40%. For example, the plastic material may be polyamide 66 with 30% glass fiber (i.e., PA66-GF30). By way of another example, the plastic material may be Polyphthalamide with 40% glass fiber (i.e., PPA-GF40).

The overmold 102 may be plastic injection molded. For example, the overmold 102 may be plastic injection molded over portions of the bars 104, the bus pins 106, and/or the neutral bus 108.

The busbar 100 may be a three-phase busbar. The busbar 100 may receive and distribute three phases of current. For example, the bus pins 106 may receive the three phases of current by the bars 104 and distribute the three phases of current from the bus pins 106. The three phases may include a first-phase (u), a second-phase (v), and a third-phase (w). The first-phase (u), the second-phase (v), and the third-phase (w) may be aligned 120-degrees out of phase.

The bars 104 may be rigid elements. Each of the bars 104 may be associated with a respective phase of electricity. The busbar 100 may include any number of the bars 104. The bars 104 may include a first-phase bar 104u, a second-phase bar 104v, and a third-phase bar 104w. The first-phase bar 104u may be associated a first-phase (u) of electricity, the second-phase bar 104v may be associated with a second-phase (v) of electricity, and the third-phase bar 104w may be associated with a third-phase (w) of electricity, respectively.

The busbar 100 may include the first-phase bar 104u, the second-phase bar 104v, and the third-phase bar 104w arranged in a sequence. For example, the second-phase bar 104v may be disposed between the first-phase bar 104u and the third-phase bar 104w.

The bus pins 106 may be rigid elements. The bus pins 106 may be connected to the bars 104. Each of the bus pins 106 may be associated with a respective phase of electricity. For example, the bus pins 106 may include first-phase bus pins 106u, second-phase bus pins 106v, and third-phase bus pins 106w. The first-phase bus pins 106u may be connected to the first-phase bar 104u, the second-phase bus pins 106v may be connected to the second-phase bar 104v, and the third-phase bus pins 106w may be connected to the third-phase bar 104w, respectively. The bus pins 106 may be connected to the bars 104 via one or more internal traces (not depicted) within the busbar 100 for distributing current from the bars 104 to the bus pins 106.

The busbar 100 may include sets of the bus pins 106 disposed along an inner-radius and/or an outer-radius of the busbar 100. A first set of the first-phase bus pins 106u, the second-phase bus pins 106v, and the third-phase bus pins 106w may be disposed along an inner-radius of the busbar 100. A second set of the first-phase bus pins 106u, the second-phase bus pins 106v, and the third-phase bus pins 106w may be disposed along an outer-radius of the busbar 100. For example, the first-phase bus pins 106u may include inner-radius, first-phase bus pins 106u-1 disposed along the inner-radius and/or may include outer-radius, first-phase bus pins 106u-4 disposed along the outer-radius. By way of another example, the second-phase bus pins 106v may include inner-radius, second-phase bus pins 106v-1 disposed along the inner-radius and/or may include outer-radius, second-phase bus pins 106v-4 disposed along the outer-radius. By way of another example, the third-phase bus pins 106w may include inner-radius, third-phase bus pins 106w-1 disposed along the inner-radius and/or may include outer-radius, third-phase bus pins 106w-4 disposed along the outer-radius. For example, the temperature sensor 112 may be arranged perpendicular to and span across the outer-radius, third-phase bus pins 106w-4.

The neutral bus 108 may be a common neutral between each of the phases. The neutral bus 108 may or may not be connected to ground.

The bus pins 106 and the neutral bus 108 may alternate in sequence. For example, the sequence may include the first-phase bus pins 106u, the neutral bus 108, the second-phase bus pins 106v, the neutral bus 108, the third-phase bus pins 106w, and the neutral bus 108 alternating in sequence. The first-phase bus pins 106u, the second-phase bus pins 106v, and the third-phase bus pins 106w may be arranged along the outer-radius and along the inner-radius in a select pattern with the neutral bus 108. For example, the inner-radius may include the neutral bus 108, followed by the inner-radius, third-phase bus pins 106w-1, followed by the neutral bus 108, followed by the inner-radius, first-phase bus pins 106u-1, followed by the neutral bus 108, followed by the inner-radius, first-phase bus pins 106v-1. By way of another example, the outer-radius may include the outer-radius, first-phase bus pins 106u-4, followed by the neutral bus 108, followed by the outer-radius, second-phase bus pins 106v-4, followed by the neutral bus 108, followed by the outer-radius, third-phase bus pins 106w-1, followed by the neutral bus 108.

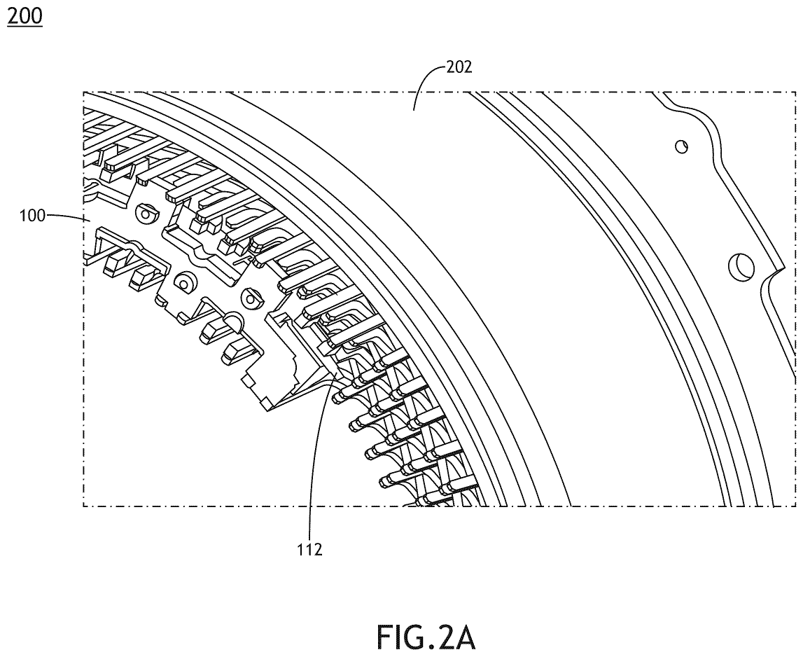

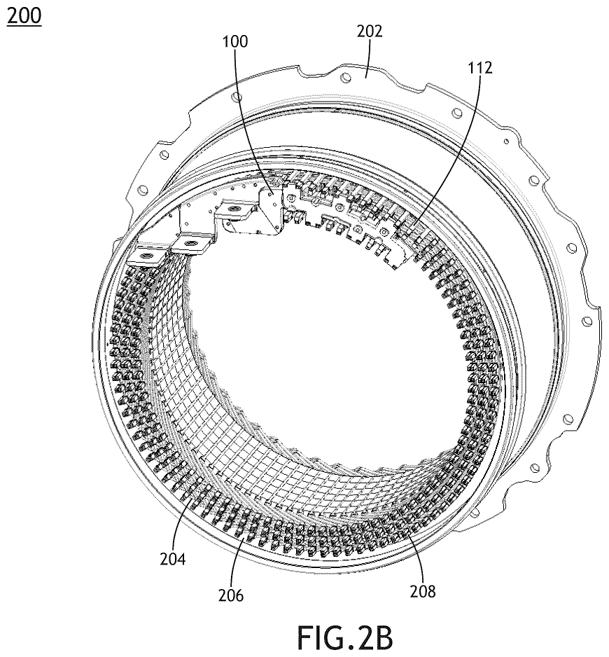

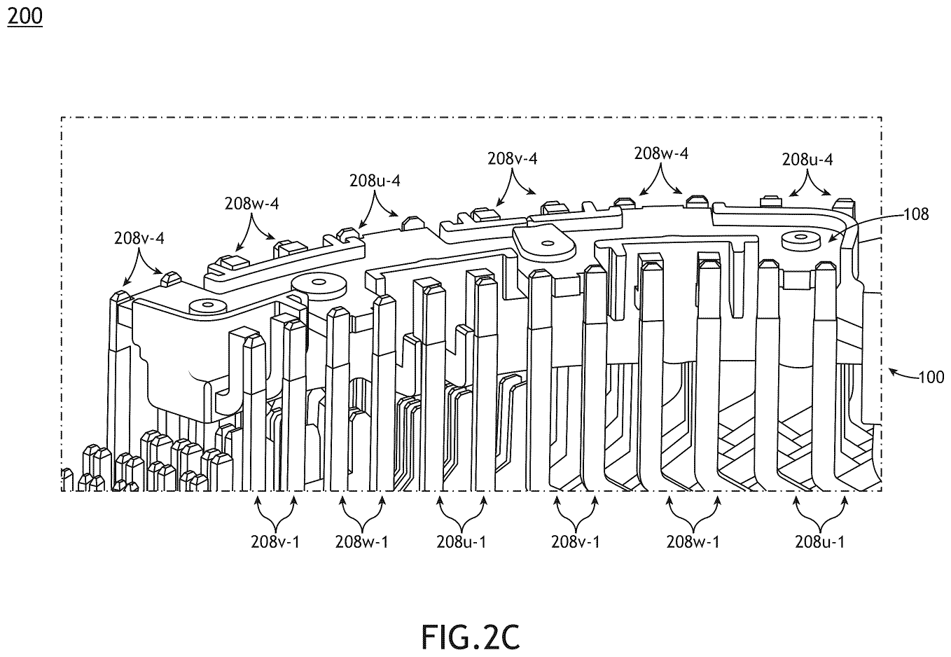

FIGS. 2A-2C depict a stator 200, in accordance with one or more embodiments of the present disclosure. The stator 200 may include the busbar 100, a stator carrier 202, a stator core 204, and/or a winding 206.

The winding 206 may include any suitable type of winding, such as, but not limited to, a hairpin winding (e.g., a hairpin lap winding) or the like. The winding 206 may include a plurality of the hairpins 208. The hairpins 208 may be joined together to form the winding 206. For example, the hairpins 208 may be joined together by a weld (e.g., a laser weld) to form the winding 206. The hairpins 208 may be flat bars which may be bent into a select shape. For example, the hairpins 208 may include a “U-shape” or the like.

The winding 206 may support the busbar 100. The busbar 100 may be disposed on and coupled to the winding 206. The hairpins 208 of the winding 206 may couple to any suitable location on the busbar 100.

The winding 206 may be electrically connected to the busbar 100. For example, the winding 206 may be electrically connected to the bus pins 106 and the neutral bus 108. The hairpins 208 may connect the winding 206 to the bus pins 106 and/or the neutral bus 108. The hairpins 208 which are connected to the bus pins 106 and the neutral bus 108 may be referred to as voltage terminals or neutral terminals, respectively. The hairpins 208 may be connected to the bus pins 106 and/or to the neutral bus 108 by one or more welds. The winding 206 may receive the current from the busbar 100 and induce a magnetic field.

The winding 206 may be a three-phase winding including the first-phase (u), the second-phase (v), and the third-phase (w). The winding 206 may include poles which alternate in sequence between the first-phase (u), the second-phase (v), and the third-phase (w). The hairpins 208 may carry a respective of the phases to define the poles. For example, the hairpins 208 may include first-phase hairpins 208u, second-phase hairpins 208v, and third-phase hairpins 208w. The first-phase hairpins 208u, second-phase hairpins 208v, and third-phase hairpins 208w may similarly be arranged in the alternating arrangement.

The first-phase hairpins 208u, second-phase hairpins 208v, and third-phase hairpins 208w may be connected to the first-phase bus pins 106u, the second-phase bus pins 106v, and the third-phase bus pins 106w, respectively. The connection between the hairpins 208 and the bus pins 106 may be referred to as a pin/pin connection. The busbar 100 may distribute current for the winding 206. For example, the busbar 100 may distribute each of the phases of current to the winding 206. The busbar 100 may distribute the three phases to the hairpins 208 through the bus pins 106.

The first-phase hairpins 208u, second-phase hairpins 208v, and third-phase hairpins 208w of the winding 206 may each be connected to the neutral bus 108. The hairpins 208 may couple the winding 206 to the neutral bus 108 of the busbar 100. The connection between the hairpins 208 and the neutral bus 108 may be referred to as a pin/neutral connection.

The winding 206 may connect to both the bus pins 106 and the neutral bus 108 of the busbar 100. The winding 206 may be a “wye” transformer by being connected at a first end to the first-phase bus pins 106u, the second-phase bus pins 106v, and the third-phase bus pins 106w, respectively, and by being connected at a second end to the neutral bus 108.

The winding 206 may also include a select number of layers. The winding 206 may include a two-layer winding, a four-layer winding, and the like. For example, the winding 206 may be the four-layer winding. The four-layer winding may include a first-layer disposed closest to the inner-radius of the stator core 204, a second-layer disposed adjacent to the first-layer, and a third-layer disposed adjacent to the second-layer, and a fourth-layer disposed closest to the outer-radius of the stator core 204. The winding 206 may include a first set of the hairpins 208 which may span between the first and second of the layers. The winding 206 may also include a second set of the hairpins 208 which may span between the third and fourth of the layers. The first set of the hairpins 208 and the second set of the hairpins 208 may each include the first-phase hairpins 208u, the second-phase hairpins 208v, and the third-phase hairpins 208w.

The hairpins 208 may be disposed in one or more layers of the winding 206. The hairpins 208 may be disposed in the first-layer, the second-layer, the third-layer, and/or the fourth-layer of the winding 206, where the winding 206 is a four-layer winding. For example, the first-phase hairpins 208u may include first-layer, first-phase hairpins 208u-1 disposed in the first-layer and/or may include fourth-layer, first-phase hairpins 208u-4 disposed in the fourth-layer. By way of another example, the second-phase hairpins 208v may include first-layer, second-phase hairpins 208v-1 disposed in the first-layer and/or may include fourth-layer, second-phase hairpins 208v-4 disposed in the fourth-layer. By way of another example, the third-phase hairpins 208w may include first-layer, third-phase hairpins 208w-1 disposed in the first-layer and/or may include fourth-layer, third-phase hairpins 208w-4 disposed in the fourth-layer.

The first-phase bus pins 106u, the second-phase bus pins 106v, and the third-phase bus pins 106w disposed along the inner-radius and the outer-radius may connect to the hairpins 208 disposed in the first-layer and the fourth-layer, respectively. For example, the first-layer, first-phase hairpins 208u-1 and the fourth-layer, first-phase hairpins 208u-4 may be connected to the inner-radius, first-phase bus pins 106u-1 and the outer-radius, first-phase bus pins 106u-4, respectively. By way of another example, the first-layer, second-phase hairpins 208v-1 and the fourth-layer, second-phase hairpins 208v-4 may be connected to the inner-radius, second-phase bus pins 106v-1 and the outer-radius, second-phase bus pins 106v-4, respectively. By way of another example, the first-layer, third-phase hairpins 208w-1 and the fourth-layer, third-phase hairpins 208w-4 may be connected to the inner-radius, third-phase bus pins 106w-1 and the outer-radius, third-phase bus pins 106w-4, respectively.

The winding 206 may define one or more poles. The poles defined by the winding 206 may be arranged in sectors around a central axis of the winding 206. For example, the winding 206 may define twelve-poles which may be arranged in thirty-degree sectors around the central axis, although this is not intended to be limiting. The winding 206 may also include greater than or less than the twelve-poles.

The hairpins 208 may include varying sizes. The varying sizes of the hairpins 208 may be based on the layers to which the hairpins 208 may be disposed. The first set of the hairpins 208 may be smaller than the second set of the hairpins 208 to maintain the alignment of the first-phase hairpins 208u, the second-phase hairpins 208v, and the third-phase hairpins 208w, respectively, in the poles across the layers.

The winding 206 may include one or more hairpins-per-pole-group. The hairpins-per-pole-group may be the number of the hairpins 208 at a select phase which are grouped to define each of the poles. The winding 206 may include one, two, three, or more of the hairpins-per-pole-group. For example, the winding 206 may include two of the hairpins-per-pole-group at a respective phase, although this is not intended as a limitation of the present disclosure. For instance, the winding 206 may include two of the first-phase hairpins 208u, two of the second-phase hairpins 208v, and two of the third-phase hairpins 208w per-pole-group.

The pole-groups of the hairpins 208 may be aligned across the layers of the winding 206, where the winding 206. For example, the first-phase hairpins 208u may be aligned, the second-phase hairpins 208v may be aligned, and the third-phase hairpins 208w may be aligned across the layers to cooperatively define the poles.

The stator carrier 202 may be a housing for the components of the stator 200. The stator carrier 202 may encapsulate the stator core 204, the winding 206, and the like. The stator core 204 and/or the winding 206 may be disposed within the stator carrier 202.

The stator core 204 may be made of stacks of one or more stacks of lamination. The stator core 204 may define one or more slots for the winding 206. The winding 206 of the stator 200 may disposed in the slots of the stator core 204. The busbar 100 may not be directly coupled to the stator carrier 202 and/or the stator core 204. Instead, the busbar 100 may be indirectly coupled to the stator carrier 202 and/or the stator core 204 via the bus pins 106, and the neutral bus 108, through the winding 206 to the stator carrier 202 and/or the stator core 204.

The number of the slots in the stator core 204 may be based on the number of hairpins-per-pole-group and the number of poles. For example, the stator core 204 may define seventy-two slots for the winding 206 where the winding 206 is a three-phase winding which defines twelve-poles and two of the hairpins-per-pole-group, although this is not intended to be limiting. Similarly, the number of the hairpins 208 may be based on the number of hairpins-per-pole-group, the number of poles, and the number of layers. For example, the stator core 204 may define seventy-two slots for the winding 206 where the winding 206 is a three-phase winding which defines twelve-poles and two of the hairpins-per-pole-group, although this is not intended to be limiting.

The hairpins 208 may span a select number of slots in the stator core 204. The number of slots in the stator core 204 to which the hairpins 208 span may be based, at least in part, on the number of hairpins-per-pole-group. In particular, the number of slots in the stator core 204 to which the hairpins 208 span may be three times the number of hairpins-per-pole-group. For example, the hairpins 208 may span six of the slots in the stator core 204 where the winding 206 include two of the hairpins-per-pole-group.

The first set of the hairpins 208 and second set of the hairpins 208 may or may not be connected across the layers. For example, the first-phase hairpins 208u of the first set of the hairpins 208 and the second set of the hairpins 208 may be connected across the layers. By way of another example, the second-phase hairpins 208v of the first set of the hairpins 208 and the second set of the hairpins 208 may be connected across the layers. By way of another example, the third-phase hairpins 208w of the first set of the hairpins 208 and the second set of the hairpins 208 may be connected across the layers. In embodiments, the first set of the hairpins 208 and second set of the hairpins 208 may be connected across the layers by a weld, a jumper, or the like.

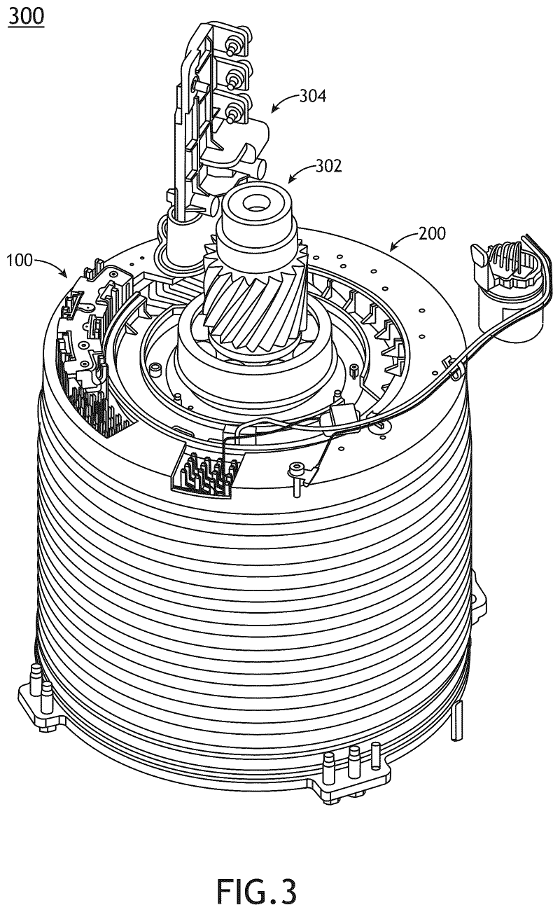

FIG. 3 depicts an electric motor 300, in accordance with one or more embodiments of the present disclosure. The electric motor 300 may be a three-phase electric motor. The electric motor 300 may include the stator 200, a rotor 302, and/or a junction box 304.

The junction box 304 may receive current from one or more external components. For example, the junction box 304 may receive current from an inverter, controller, or the like. The junction box 304 may receive one or more phases of current. The junction box 304 may receive the three phases of current, including the first-phase (u), the second-phase (v), and the third-phase (w).

The junction box 304 may be connected to the busbar 100. The busbar 100 may receive the current from the junction box 304. The bars 104 of the busbar 100 may couple to the junction box 304 for receiving the current. The bus pins 106 may connect to the winding 206. The busbar 100 may distribute the three phases of current to the winding 206. For example, the bus pins 106 may be connected to the winding 206 for distributing the three phases of current. The winding 206 may receive the current from the busbar 100. The winding 206 may induce a magnetic field in response to receiving the three phases of current from the busbar 100.

The rotor 302 may be disposed within the central axis of the stator 200. The rotor 302 may be supported by the stator 200 via one nor more bearings. The magnetic field induced by the winding 206 may cause the rotor 302 to rotate relative to the stator 200. The rotor 302 may perform work on one or more external components via the rotation of the rotor 302. Thus, the electric motor 300 may be a dynamo-electric machine which converts electrical energy to mechanical energy by electromagnetic means.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 busbar
102 overmold
104 bars
104u first-phase bar
104v second-phase bar
104w third-phase bar
106 bus pins
106u first-phase bus pins
106u-1 inner-radius, first-phase bus pins
106u-4 outer-radius, first-phase bus pins
106v second-phase bus pins
106v-1 inner-radius, second-phase bus pins
106v-4 outer-radius, second-phase bus pins
106w third-phase bus pins
106w-1 inner-radius, third-phase bus pins
106w-4 outer-radius, third-phase bus pins
108 neutral bus
110 mounting point
112 temperature sensor
200 stator
202 stator carrier
204 stator core
206 winding
208 hairpins
208u first-phase hairpins
208u-1 first-layer, first-phase hairpins
208u-4 fourth-layer, first-phase hairpins
208v second-phase hairpins
208v-1 first-layer, second-phase hairpins
208v-4 fourth-layer, second-phase hairpins
208w third-phase hairpins
208w-1 first-layer, third-phase hairpins
208w-4 fourth-layer, third-phase hairpins
300 electric motor
302 rotor
304 junction box

What is claimed:

1. A busbar comprising:
a plurality of bars;
a plurality of bus pins, wherein the plurality of bus pins are connected to the plurality of bars;
a neutral bus; and
an overmold configured to support the plurality of bars, the plurality of bus pins, and the neutral bus, wherein the overmold comprises:
a mounting point, wherein the overmold is configured to couple to a temperature sensor at the mounting point.

2. The busbar of claim 1, wherein the temperature sensor is located between the plurality of bus pins and the overmold.

3. The busbar of claim 2, wherein the temperature sensor is in contact with at least two bus pins of the plurality of bus pins.

4. The busbar of claim 1, wherein the temperature sensor is molded within the overmold.

5. The busbar of claim 4, wherein the temperature sensor is in contact with the neutral bus.

6. The busbar of claim 4, wherein the temperature sensor is located between the overmold and the neutral bus.

7. The busbar of claim 1, wherein the temperature sensor runs perpendicular to the plurality of bus pins.

8. The busbar of claim 1, wherein the temperature sensor is located at a corner of the busbar.

9. The busbar of claim 1, wherein the temperature sensor is located proximal to the neutral bus.

10. The busbar of claim 1, wherein the overmold is configured such that the temperature sensor is at least one of press fit or snap fit into the overmold.

11. The busbar of claim 1, wherein the busbar is a three-phase busbar, wherein the plurality of bars comprise a first-phase bar, a second-phase bar, and a third-phase bar, wherein the plurality of bus pins comprise a plurality of first-phase bus pins, a plurality of second-phase bus pins, and a plurality of third-phase bus pins, wherein the plurality of first-phase bus pins are connected to the first-phase bar, wherein the plurality of second-phase bus pins are connected to the second-phase bar, wherein the plurality of third-phase bus pins are connected to the third-phase bar.

12. The busbar of claim 11, wherein a first set of the plurality of first-phase bus pins, the plurality of second-phase bus pins, and the plurality of third-phase bus pins are disposed along an inner-radius, wherein a second set of plurality of first-phase bus pins, the plurality of second-phase bus pins, and the plurality of third-phase bus pins are disposed along an outer-radius.

13. A stator comprising:
a busbar comprising:
a plurality of bars;
a plurality of bus pins, wherein the plurality of bus pins are connected to the plurality of bars;
a neutral bus; and
an overmold configured to support the plurality of bars, the plurality of bus pins, and the neutral bus, wherein the overmold comprises:
a mounting point, wherein the overmold is configured to couple to a temperature sensor at the mounting point;
a stator core;
a winding, wherein the winding is electrically connected to the plurality of bus pins and the neutral bus, the winding comprising a plurality of hairpins; and
the temperature sensor, wherein the temperature sensor is coupled to the mounting point and additionally abuts at least one of the neutral bus or one or more pins of the plurality of bus pins.

14. The stator of claim 13, wherein the temperature sensor is located between the plurality of bus pins and the overmold.

15. The stator of claim 13, wherein the temperature sensor is molded within the overmold.

16. The stator of claim 15, wherein the temperature sensor is located between the overmold and the neutral bus.

17. An electric motor comprising:
a rotor; and
a stator comprising:
a busbar comprising:
a busbar comprising:
a plurality of bars;
a plurality of bus pins, wherein the plurality of bus pins are connected to the plurality of bars;
a neutral bus; and
an overmold configured to support the plurality of bars, the plurality of bus pins, and the neutral bus, wherein the overmold comprises:
a mounting point, wherein the overmold is configured to couple to a temperature sensor at the mounting point;
a stator core;
a winding, wherein the winding is electrically connected to the plurality of bus pins and the neutral bus, the winding comprising a plurality of hairpins; and
the temperature sensor, wherein the temperature sensor is coupled to the mounting point and additionally abuts at least one of the neutral bus or one or more pins of the plurality of bus pins.

18. The electric motor of claim 17, wherein the temperature sensor is located between the plurality of bus pins and the overmold.

19. The electric motor of claim 17, wherein the temperature sensor is molded within the overmold.

20. The electric motor of claim 19, wherein the temperature sensor is located between the overmold and the neutral bus.
